(19) United States
(12) Patent Application Publication
(10) Pub. No.: US 2025/0174795 A1
(43) Pub. Date: May 29, 2025

(54) BATTERY PACK

(71) Applicant: TOYOTA JIDOSHA KABUSHIKI KAISHA, Toyota-shi Aichi-ken (JP)

(72) Inventors: Masayuki HASHIMOTO, Nagoya-shi Aichi-ken (JP); Shigeyuki INOUE, Toyota-shi Aichi-ken (JP); Kotaro HORIGUCHI, Nagoya-shi Aichi-ken (JP); Daiki OGAWA, Nagoya-shi Aichi-ken (JP)

(73) Assignee: TOYOTA JIDOSHA KABUSHIKI KAISHA, Toyota-shi Aichi-ken (JP)

(21) Appl. No.: 18/952,463

(22) Filed: Nov. 19, 2024

(30) Foreign Application Priority Data
Nov. 27, 2023 (JP) 2023-200206

(51) Int. Cl. H01M 50/242; B60L 50/64; B60L 58/10; H01M 10/48; H01M 50/249

(52) U.S. Cl. CPC H01M 50/242; B60L 50/64; H01M 10/48; H01M 50/249; B60L 58/10; H01M 2220/20

(57) ABSTRACT

A battery pack includes: a lower case for accommodating a battery cell; a protective structure, disposed below the lower case, for protecting the battery cell against a load from below; and a sensor for detecting a load input from the protective structure to the lower case. Further, the protective structure includes a share panel forming a lowest layer and an elastic body interposed between the share panel and the lower case, the elastic body is elastically deformed by a load from below and causes a displacement of the share panel with respect to the lower case, and the sensor is disposed in a same layer as the elastic body is disposed between the lower case and the share panel to detect a load input to the lower case in accordance with the displacement of the share panel when the elastic body is elastically deformed.

### CROSS-REFERENCE TO RELATED APPLICATION(S)

The present application claims priority to and incorporates by reference the entire contents of Japanese Patent Application No. 2023-200206 filed in Japan on Nov. 27, 2023.

### BACKGROUND

The present disclosure relates to a battery pack.

Japanese Patent No. 7216354 discloses a vehicle in which a battery pack is mounted on a vehicle casing floor, as a structure for protecting the battery pack, including a plate-shaped underguard disposed below the case of the battery pack, and a resin cover attached to the bottom surface of the underguard. In the configuration described in Japanese Patent No. 7216354, when the impact due to road surface interference is input to the resin cover, the first absorbs the impact by the resin cover is deformed, if the deformation of the cover cannot absorb the impact plate-like underguard absorbs the impact by deforming.

### SUMMARY

There is a need for providing a battery pack capable of controlling a displacement for sensor detection and detecting a road surface input by a sensor even if it is a protective structure that is hardly deformed when subjected to a load due to road surface interference.

According to an embodiment, a battery pack includes: a lower case for accommodating a battery cell; a protective structure, disposed below the lower case, for protecting the battery cell against a load from below; and a sensor for detecting a load input from the protective structure to the lower case. Further, the protective structure includes a share panel forming a lowest layer and an elastic body interposed between the share panel and the lower case, the elastic body is elastically deformed by a load from below and causes a displacement of the share panel with respect to the lower case, and the sensor is disposed in a same layer as the elastic body is disposed between the lower case and the share panel to detect a load input to the lower case in accordance with the displacement of the share panel when the elastic body is elastically deformed.

### BRIEF DESCRIPTION OF THE DRAWINGS

FIG. 1 is a diagram schematically illustrates a battery pack according to an embodiment;

FIG. 2 is a diagram for explaining characteristics of a sensor; and

FIG. 3 is a diagram schematically illustrating a protective structure according to modified example.

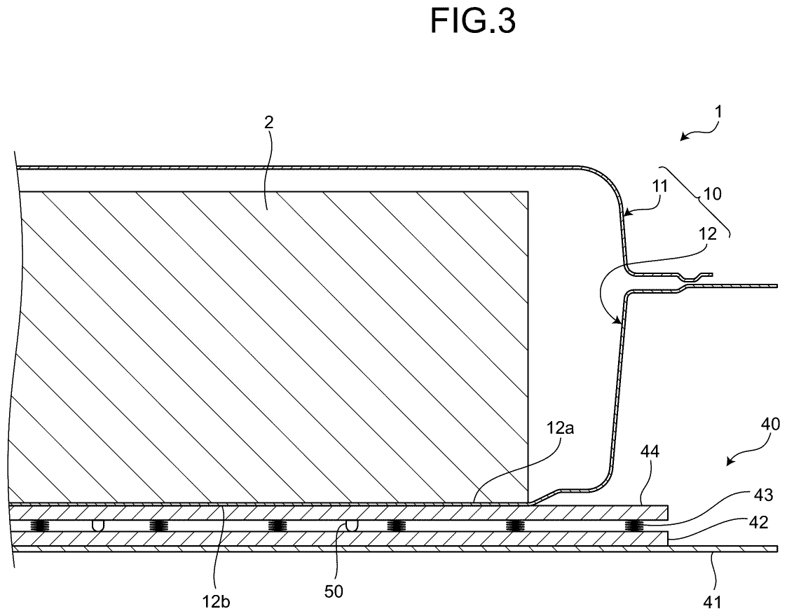

### DETAILED DESCRIPTION

Although the configuration described in Japanese Patent No. 7216354 absorbs the load due to the road surface interference by the underguard as a protective structure for protecting the battery cells from road surface interference is greatly deformed, it did not disperse the collision load by the protective structure that is not easily deformed.

Hereinafter, a battery pack according to an embodiment of the present disclosure will be specifically described. Note that the present disclosure is not limited to the embodiments described below.

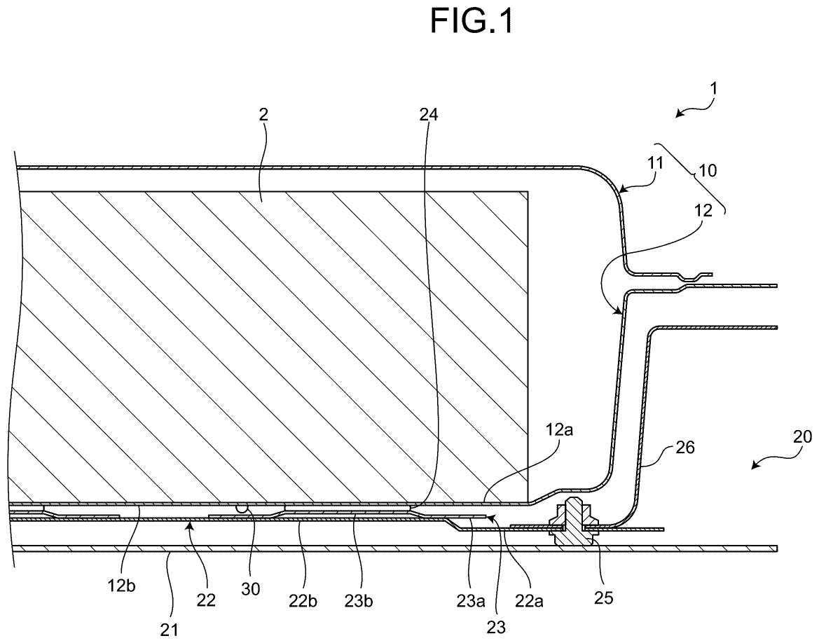

FIG. 1 is a diagram illustrating a battery pack according to an embodiment. A battery pack 1 is to be mounted on an electric vehicle, and supplies power to the motor for traveling. The battery pack 1 is disposed below the floor panel of the electric vehicle.

The battery pack 1 includes a battery cell 2, a case 10, and a protective structure 20.

The case 10 houses a battery module constituted by a plurality of battery cells 2. Inside the case 10, a plurality of battery modules are housed. In the electric vehicle, the case 10 disposed below the floor panel is fixed to the vehicle body. For example, the case 10 is fixed to the locker or the cross member via a fixing member such as a bracket.

The case 10 includes an upper case 11, and a lower case 12. The upper case 11 is disposed above the battery cell 2, and is formed so as to cover the opening of the lower case 12. The lower case 12 is disposed below the battery cell 2, and is a case member on which the battery cell 2 is placed. The lower case 12 has an opening that opens upward, and a bottom 12a in which the cell 2 is placed. The upper case 11 and the lower case 12 are integrated by a fastening member such as a bolt. A plurality of battery modules are accommodated in the internal space formed by the upper case 11 and the lower case 12 in the battery pack 1. The case 10 is fixed by fastening the flange portion of the lower case 12 to the body such as a rocker of the electric vehicle.

The protective structure 20 is a structure for protecting the battery cell 2 from road surface interference. In the electric vehicle equipped with the battery pack 1, when the battery pack 1 is attached to the lower part of the vehicle body, a road surface interference occurs in which curbs and obstacles collide with the lower part of the battery pack 1. When the road surface interference occurs, a collision load from below is input to the battery pack 1. To protect the battery cell 2 from this collision load, the protective structure 20 is disposed below the battery cell 2.

The protective structure 20 includes a share panel 21, a reinforcing member 22, a pressing member 23, and an elastic member 24.

The protective structure 20 is not a large deformation structure that absorbs the energy of the road surface interference by the share panel 21 is greatly deformed, a small deformation structure that disperses the input to the battery cell 2 by receiving a collision load in the lower structure. The protective structure 20 is a structure that hardly deformed.

The share panel 21 is a member in which curbs or obstacles or the like collide with each other due to the road surface interference, and is a member in which a collision load caused by the road surface interference is input. The share panel 21 is disposed lowermost of the protective structure 20, it is formed in a flat plate shape so as to cover the entire bottom 12b of the lower case 12 from below. The share panel 21 forms the lowermost layer of the protective structure 20. In the protective structure 20, the collision load input to the share panel 21 is transmitted from the share panel 21 to the reinforcing member 22. The share panel 21 is disposed below the reinforcing member 22 is integrated with the reinforcing member 22. For example, the share panel 21 is attached to the lower portion of the reinforcing member 22 by a fastening member such as a bolt or pin.

The reinforcing member 22 is a reinforcing panel which receives the collision load transmitted from the share panel 21. The reinforcing member 22 is formed so as to cover the entire bottom 12b of the lower case 12 from below. The reinforcing member 22 is integrated with the support member 26 by a bolt 25. The support member 26 is fixed to the vehicle body. The reinforcing member 22 has a flat plate portion 22a, and a convex portion 22b which is convex on top.

The flat plate portion 22a is formed to include a peripheral portion of the reinforcing member 22, to form a portion where the share panel 21 is attached. The convex portion 22b forms a central portion of the reinforcing member 22 is formed in a convex shape upward from the flat plate portion 22a. The flat plate portion 22a is formed around the convex portion 22b. The convex portion 22b is disposed below the place where the cell 2 is placed. In the protective structure 20, the collision load input to the share panel 21 is configured to transmit from the reinforcing member 22 to the pressing member 23. The reinforcing member 22 is integrated with the pressing member 23 in a state of being disposed below the pressing member 23. For example, the convex portion 22b of the reinforcing member 22 by welds or the like is joined to the lower portion of the pressing member 23.

The pressing member 23 is a pressing panel for pressing the elastic member 24 by the collision load transmitted from the reinforcing member 22. The pressing member 23 is in surface contact with the lower surface of the elastic member 24 in a state of being disposed below the elastic member 24. The pressing member 23 has a flat plate portion 23a, and a convex portion 23b which is convex on top.

The flat plate portion 23a is a site that is attached to the convex portion 22b of the reinforcing member 22. While the upper surface of the lower surface and the convex portion 22b of the flat plate portion 23a is in surface contact, the pressing member 23 is integrated into the reinforcing member 22. The convex portion 23b is formed in a convex shape upward from the flat plate portion 23a. The protrusion 23b is provided below the location where the elastic member 24 is provided and above the location where the convex portion 22b of the reinforcing member 22 is provided. In the protective structure 20, the collision load input to the share panel 21 is configured to transmit from the pressing member 23 to the elastic member 24. The pressing member 23, the upper surface of the convex portion 23b becomes a pressing surface, and presses the elastic member 24 upward by the impingement load transmitted from the reinforcing member 22.

The elastic member 24 is an elastic body interposed between the share panel 21 and the lower case 12 is formed in a flat plate shape. The elastic member 24 is sandwiched between the bottom 12a of the convex portion 23b and the state case 12 of the pressing member 23 while in surface contact with the bottom 12b of the lower case 12. The elastic member 24 is elastically deformed to compress upward receiving a load from the pressing member 23. In the protective structure 20, the elastic member 24 is elastically deformed to cause displacement of the share panel 21 required for load detection by the sensor 30 by the transmission of the collision load input to the share panel 21 to the elastic member 24.

Further, in the protective structure 20, a plurality of elastic members 24 and pressing members 23 are provided. The bottom 12b of the lower case 12 a plurality of elastic members 24 are in surface-contact. The pressing members 23 are provided at respective positions corresponding to the plurality of elastic members 24. Of the transmission path of the load applied to the elastic member 24 by the input from the share panel 21, the reinforcing member 22 is provided on the transmission path from the share panel 21 to the pressing member 23. The reinforcing member 22 distributes the collision load, to transmit the load to the plurality of pressing members 23. When the protective structure 20 receives the collision load, the collision load inputted to the bottom 12a of the lower case 12 is dispersed. The protective structure 20 allows the input to be dispersed to the lower portion of the battery cell 2.

Furthermore, below the lower case 12, a switch-type sensor 30 for detecting the load is provided. The battery pack 1 is configured to include a sensor 30. The battery pack 1 has a protective structure 20 and a sensor 30 as a substructure.

The sensor 30 is configured to detect a load in accordance with the deformation amount of the elastic member 24. The sensor 30 detects the load input from the protective structure 20 to the lower case 12. The sensor 30 is disposed between the upper surface of the state plate portion 23a of the bottom 12b and the pressing member 23 of the lower case 12, and is attached to the bottom 12b while separated from the flat plate portion 23a.

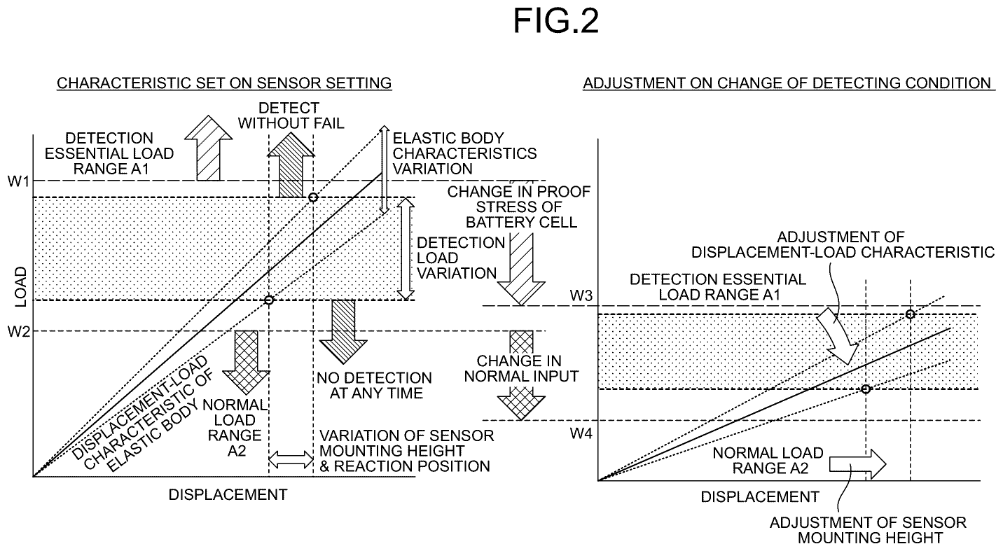

The sensor 30 is disposed in the same layer as the elastic member 24 between the lower case 12 and the share panel 21. The sensor 30 detects the load in accordance with the displacement of the protective structure 20 when the elastic member 24 is elastically deformed. The protective structure 20, together with the share panel 21 and the reinforcing member 22 and the pressing member 23 is integrated structure, a structure that distributes the load hardly deformed with respect to the road surface input. The displacement of the protective structure 20, represents that the shear panel 21 and the reinforcing member 22 and the pressing member 23 is displaced together. That is, the displacement of the protective structure 20 can be referred to as the displacement of the share panel 21 relative to the lower case 12. If the elastic member 24 is elastically deformed so as to compress upward, the position of the pressing member 23 so that the distance between the bottom 12b of the lower case 12 and the upper surface of the flat plate portion 23a is narrowed is displaced. The elastic member 24 is elastically deformed by the load from below by the road surface input, causing displacement of the share panel 21 relative to the lower case 12. Then, the upward deformation of the elastic member 24 is increased, by the flat plate portion 23a of the pressing member 23 comes into contact with the sensor 30, the sensor 30 detects the load. The sensor 30 is set to the characteristics of the displacement and the load as illustrated in FIG. 2.

As illustrated in FIG. 2, the sensor 30, the characteristics of the displacement and the load in the elastic member 24, variation occurs in the detection load in accordance with the variation of the sensor mounting height and reaction position. The elastic member 24, when the sensor 30 detects a load in a predetermined range, elastically deformed so as to absorb the collision load. The sensor 30, in view of the variation of the detection load, is set so that the sensor 30 always detects the load included in the detection load range A1, and so that the sensor 30 dose not detect the load included in the normal load range A2 at any time. The load range A1 that must be detected is the load range that is greater than or equal to the load W1. The normal load range A2 is the load range below the load W2. The load W1 is larger than the load W2. The variation of the detected load is included in the area larger than the load W2 and smaller than the load W1. In other words, the sensor 30 is configured to detect the load W1 which is the lower limit value of the load range A1 that is to be detected without fail and not to detect the load W2 which is the upper limit value of the normal load range A2 without fail.

In addition, in the battery pack 1, as illustrated in FIG. 2, it is assumed that the load range A1 that needs to be detected is widened by changing and changing the proof stress of the battery cell 2. In addition, it is assumed that the normal load range A2 is narrowed by changing or changing the normal input of the battery pack 1. In such cases, the lower limit of the load range A1, which must be detected, becomes the load W3. The load W3 is smaller than the load W1. In addition, the upper limit of the normal load range A2 becomes the load W4. The load W4 is smaller than the load W2. As the detection condition changes accordingly, the sensing performance of the sensor 30 is adjusted. Adjustment is made in the characteristics of the displacement and the load in the elastic member 24 and in the mounting height of the sensor 30. Through the adjustment, the sensor 30 detects a load that is less than or equal to the allowable input of the battery cell 2, and adjusts the sensing performance so that the sensor does not detect a load that can guarantee the function. The sensor 30 after the adjustment is set so that the sensor 30 always detects the load W3 which is the lower limit value of the load range A1 that is to be detected, and so that the sensor does not detect the load W4 which is the upper limit value of the normal load range A2 at any time.

As described above, according to the embodiment, it is possible for the sensor 30 to appropriately detect the load with respect to the protective structure 20 having a small deformation for dispersing the input to the battery cell 2 by receiving a load in the lower structure of the battery pack 1.

Further, in the battery pack 1 of the modification includes a protective structure 40 disposed below the lower case 12. The protective structure 40 includes a share panel 41, a lower panel 42, a spring 43, and an upper panel 44.

The share panel 41 forms the lowermost layer of the protective structure 40. The lower panel 42 is a plate-shaped reinforcing panel is attached to the upper surface of the share panel 41. The lower panel 42 is integrated with the share panel 41. The upper panel 44 is a plate-shaped reinforcing panel is disposed between the lower panel 42 and the lower case 12. The upper panel 44 is attached to the bottom 12b of the lower case 12. The share panel 41 and the lower panel 42 and the upper panel 44 is constituted by a member and structure hardly deformed.

The spring 43 is a spring-like member that expands and contracts in the vertical direction, are arranged so as to connect between the lower panel 42 and the upper panel 44. The spring 43 is an elastic body interposed between the share panel 41 and the lower case 12. The spring 43 causes displacement of the share panel 21 required for load detection by the sensor 30 by compressive deformation in the vertical direction (elastic deformation).

Between the lower panel 42 and the upper panel 44, a sensor 50 for detecting the load is provided. In this modification, the sensor 50 is incorporated in the protective structure 40.

The sensor 50 is configured to detect a load in accordance with the deformation amount of the spring 43. The sensor 50 detects the load input from the protective structure 40 to the lower case 12. The sensor 50 is disposed between the upper surface of the lower surface and the lower panel 42 of the upper panel 44, is attached to the lower surface of the upper panel 44 in a state of being separated from the upper surface of the lower panel 42.

The sensor 50 is disposed in the same layer as spring 43 between lower case 12 and share panel 41. The sensor 50 detects a load in accordance with the displacement of the protective structure 40 when the spring 43 is elastically deformed. If the spring 43 is elastically deformed to compress in the vertical direction, the position of the lower panel 42 so that the distance between the upper surface of the lower panel 42 and the lower surface of the upper panel 44 is narrowed is displaced. Then, the amount of compression of the spring 43 is increased, by the lower panel 42 comes into contact with the sensor 50, the sensor 50 detects the load. The sensor 50 can be set to the characteristics of displacement and load as illustrated in FIG. 2.

In the present disclosure, even a protective structure that is hardly deformed when subjected to a load due to road surface interference, it is possible to detect the road surface input by a sensor.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A battery pack comprising:
a lower case for accommodating a battery cell;
a protective structure, disposed below the lower case, for protecting the battery cell against a load from below; and
a sensor for detecting a load input from the protective structure to the lower case, wherein
the protective structure includes
a share panel forming a lowest layer, and
an elastic body interposed between the share panel and the lower case,
the elastic body is elastically deformed by a load from below and causes a displacement of the share panel with respect to the lower case, and
the sensor is disposed in a same layer as the elastic body is disposed between the lower case and the share panel to detect a load input to the lower case in accordance with the displacement of the share panel when the elastic body is elastically deformed.

2. The battery pack according to claim 1, wherein
the elastic body is a flat plate-shaped elastic member that is in surface contact with a bottom surface of the lower case,
the protective structure includes
a pressing panel, which is in surface contact with a lower surface of the elastic member, for pressing the elastic member upward, and
a reinforcing panel interposed between the share panel and the pressing panel,
the elastic member is provided with a plurality at different positions of the bottom surface of the lower case,
the pressing panel is provided at a position corresponding to the elastic member,
the reinforcing panel is provided on a transmission path from the share panel to the pressing panel of the load applied to the elastic member by an input from the share panel to disperse and transmit the load to the pressing panel.

3. The battery pack according to claim 1, wherein
the protective structure includes
a lower panel integrated with the share panel, and
an upper panel disposed between the lower panel and the lower case, and
the elastic body is a spring-like member and is disposed so as to connect between the lower panel and the upper panel.
